(19) United States
(12) Patent Application Publication
(10) Pub. No.: US 2009/0237607 A1
(43) Pub. Date: Sep. 24, 2009

(54) LIQUID CRYSTAL DISPLAY PANEL MEMBER, LIQUID CRYSTAL DISPLAY PANEL USING LIQUID CRYSTAL DISPLAY PANEL MEMBER, AND LIQUID CRYSTAL DISPLAY DEVICE

(75) Inventor: Toshihiko Hosokawa, Kagoshima (JP)

Correspondence Address: BIRCH STEWART KOLASCH & BIRCH, PO BOX 747, FALLS CHURCH, VA, 22040-0747, US

(73) Assignee: KYOCERA CORPORATION, Kyoto (JP)

(21) Appl. No.: 12/306,223

(22) PCT Filed: Jun. 26, 2007
(86) PCT No.: PCT/JP2007/062827

§ 371 Date: Jan. 22, 2009

(30) Foreign Application Priority Data
Jun. 28, 2006 (JP) 2006-178802

(51) Int. Cl. G02F 1/1339

(52) U.S. Cl. 349/153

(57) ABSTRACT

The object of the invention is to provide a liquid crystal display panel member, a liquid crystal display panel, and liquid crystal display device that make it possible to improve image quality in the neighborhood of the open area portion of a sealing member such as an opening for filling liquid crystal and enhance the adhesion reliability of the sealing member in the neighborhood of the open area portion.

A liquid crystal display panel member according to an embodiment of the invention has a first base 10 including a transparent substrate 11 and a first electrode 12, a second base 20 including a transparent substrate 21 and a second electrode 22, and a sealing member 30 for sealing liquid crystal to be placed between the first base 10 and the second base 20. The sealing member 30 has a filling opening 31 through which liquid crystal is to be injected. A part of at least either one of the first electrode 12 and the second electrode 22 is arranged in the formation area of the filling opening 31. At least either one of the first base 10 and the second base 20 has a gap adjustment portion 40 which is arranged in a non-formation area of the first electrode or the second electrode and arranged in the formation area of the opening portion. The adjustment portion is configured to adjust a gap between the first base and the second base.

### TECHNICAL FIELD

The present invention relates to a liquid crystal display panel member, a liquid crystal display panel that has a liquid crystal layer formed in the liquid crystal display panel member, and a liquid crystal display device. In particular, the invention relates to a technique for preventing, for example, any degradation in image quality in the neighborhood of an opening for filling liquid crystal.

### RELATED ART

These days, a liquid crystal display panel is widely used as a component of a relatively small information communication device such as a handheld information terminal or the like and a relatively large high definition display device such as a monitor or the like.

FIG. 5 is a plan view that illustrates the configuration of a liquid crystal display panel member which shows a state before forming a liquid crystal layer. As shown in FIG. 5, a liquid crystal display panel has a first base 100 including a transparent substrate and first electrodes on one surface of the transparent substrate, a second base 200 including a transparent and second electrodes on one surface of the transparent substrate, and a sealing member 300 for sealing liquid crystal to be placed between the first base 100 and the second base 200. The sealing member 300 includes a filling opening 310 for filling the liquid crystal. The filling opening 310 is open toward an end of each of the first base 100 and the second base 200. An image display area is formed in such a manner that the first electrodes and the second electrodes are provided opposite to each other. Liquid crystal is filled in through filling opening 310, ant then, the filling opening 310 is sealed with a filling-opening sealing member, whereby a liquid crystal display panel is formed.

The filling-opening sealing member is formed by applying a curable resin such as a thermosetting epoxy resin, an ultraviolet ray curing acrylic resin or the like onto the filling opening 310 and then hardening the applied curable resin. Therefore, the gap distance between the first base 100 and the second base 200 measured in the neighborhood of the filling opening 310 is likely to be smaller than the gap distance between the first base 100 and the second base 200 measured at the image display area side because the curable resin, which is the material of filling-opening sealing member, shrinks in the process of the hardening thereof in the neighborhood of the filling opening 310. If such shrinkage occurs, the thickness of a liquid crystal layer that is sealed inside between the first base 100 and the second base 200 becomes uneven. For this reason, display unevenness might occur in the neighborhood of the filling opening 310.

As a method for preventing the occurrence of display unevenness in the neighborhood of the filling opening 310, the patent document 1 proposes a configuration in that a display electrode, a color filter and a dummy portion of a black mask are arranged at the filling opening 310. More specifically, a common ITO constituting the display electrode, and a dummy ITO, which are positioned at the filling opening, are extended in the longitudinal direction of the common ITO and the dummy ITO to form an extending portion which is positioned at the filling opening. In case of forming a color filter dummy, an additional color filter is provided. The additional color filter is positioned at the filling opening. As for the black mask, a black mask dummy portion is formed as an extended part of the black mask so as to correspond to the filling opening. The black mask dummy portion is positioned at the filling opening. As explained above, since an additional portion that lies at the filling opening is provided for each of the above-mentioned members, a configuration that a film structure in the periphery of a display area portion is the same as a film structure at the filling opening, and that there is no step at the filling opening can be prevented from occurring gap defect. Moreover, since there is no step in the neighborhood of the filling opening, it is easier to control suction amount.

The patent documents proposes a technique for reducing cell gap unevenness in the neighborhood of a filling opening, which is achieved by forming a filling-opening sealing dummy circuit pattern that has a light-transmitting opening portion at the filling opening.

### Patent Document 1: Japanese Unexamined Patent Application Publication No. 10-73830

### Patent Document 2: Japanese Unexamined Patent Application Publication No. 2005-242099

### DISCLOSURE OF INVENTION

### Problems to be Solved by the Invention

However, the features of the techniques disclosed in the patent documents 1 and 2 described above are merely to provide dummy portions at a filling opening. The dummy portion extends toward an end face of a substrate in parallel with a sealing member that forms the filling opening. The position of the dummy portion and the positional relationships between the dummy portion and a transparent substrate (base) are not adjusted at all. The position of the dummy and the size thereof in the direction of thickness thereof and the direction of the edge line of each base are not adjusted. Therefore, according to the techniques described in the patent documents 1 and 2, it is not possible to achieve uniform filling amount of a sealing member, which forms a filling opening through which liquid crystal is injected, throughout an image display area side and a base end side in a satisfactory manner. Thus, it is not possible to adjust the thickness of a liquid crystal layer with high precision.

Problems that arise in a case where, as explained above, the filling amount of the sealing member, which forms the filling opening through which liquid crystal is injected, is not uniform are explained in detail below while referring to FIGS. 6, 7, and 8.

FIG. 6 is a partial plan view that illustrates, in an enlarged view, the area C of the liquid crystal display panel member that is shown in FIG. 5. Specifically, FIG. 6 is a partial plan view that illustrates a virtually split sealing member 300, which is assumed to be split into two parts at substantially the center thereof when viewed in the direction of thickness thereof, together with a second base 200, which is provided as an upper base. FIG. 7 is a sectional view that illustrates the relevant components of a liquid crystal display panel member, taken along the line I′-I′ of FIG. 5. FIG. 8 is a sectional view that illustrates the relevant components of a liquid crystal display panel that is formed by injecting liquid crystal into a conventional liquid crystal display panel member, and then sealing a filling opening with a filling-opening sealing member 500.

As shown in FIGS. 6 and 7, the sealing member 300, which is made of a thermosetting resin or the like that includes inner sealing member spacers 300a for securing a gap between the first base 100 and the second base 200, serves to bond the first base 100 and the second base 200 to each other. The sealing member 300 has a peripheral portion that is formed at the periphery of each of the first base 100 and the second base 200, and an open area portion which is open toward an end of each of the first base 100 and the second base 200 to form the filling opening 310.

As shown in FIG. 7, the gap distance between the first base 100 and the second base 200 measured at the opening side of the liquid crystal filling opening 310 at which no first electrode 120 or second electrode 220 is formed is larger in comparison with the gap distance between the first base 100 and the second base 200 measured at the image display area side. During an initial thermosetting process, the viscosity of the sealing member 300 decreases so that the sealing member 300 starts to gradually harden. Thereafter, for example, the sealing member 300 becomes hardened completely at the lapse of around one hour and under the temperature of around 1500C. In addition, since the sealing member 300 includes a material having a large “viscosity down” property whose complex coefficient of viscosity at the maximum softening point in a temperature range from 50° C. to 120° C. is 10 Pa·sec or less in order to enhance adhesion strength and electric conductivity, a relatively large amount of the resin moves from a relatively large gap area portion (i.e., the filling opening 310) toward a relatively small gap area portion (i.e., the image display area) due to a capillary phenomenon until it becomes hardened through heating. For this reason, as shown in FIGS. 6 and 7, the formed sealing member 300 partially has a thin area or a non-formation area thereof at the opening side of the liquid crystal filling opening 310. As a result thereof, when a liquid crystal display panel shown in FIG. 8 is formed with the use of a liquid crystal display panel member, poor injection frequently occurs due to the entrainment of air bubbles or the like during the injection of liquid crystal through the filling opening 310. At the time when the filling opening 310 is sealed by means of the filling-opening sealing member 500 after the injection of the liquid crystal therethrough, the resin material of the filling-opening sealing member 500 goes into, at the opening side of the filling opening 310, the non-formation area at which the sealing member 300 is not formed. Then, the filling-opening sealing member 500 shrinks during its hardening process. For this reason, the gap distance D′2 between the first base 100 and the second base 200 measured at the opening side of the liquid crystal filling opening 310 becomes smaller than the gap distance D′1 between the first base 100 and the second base 200 measured at the image display area side. As a consequence thereof, the thickness of a liquid crystal layer 510 measured in the image display area becomes uneven. Thus, the strength of an electric field that is applied to the liquid crystal layer 510 is also not uniform, which causes display unevenness.

In view of the foregoing problems, an object of the present invention is to provide a liquid crystal display panel member, a liquid crystal display panel, and liquid crystal display device that make it possible to improve image quality in the neighborhood of an opening for filling liquid crystal and enhance the adhesion reliability of a sealing member in the neighborhood of the filling opening.

### Means for Solving the Problems

A liquid crystal display panel member according to an aspect of the invention includes: a first base that includes a first transparent substrate and a first electrode, the first electrode being formed on one main surface of the first transparent substrate; a second base that includes a second transparent substrate and a second electrode, the second electrode being formed on one main surface of the second transparent substrate; and a sealing member for sealing liquid crystal to be placed between the first base and the second base, wherein the sealing member constitutes an opening portion, which is open toward an end of each of the first base and the second base; a part of at least either one of the first electrode and the second electrode is arranged in the formation area of the opening portion; and at least either one of the first base and the second base has an adjustment portion which is arranged in a non-formation area of the first electrode or the second electrode and arranged in the formation area of the opening portion, the adjustment portion being configured to adjust a gap between the first base and the second base.

In the configuration of a liquid crystal display panel member according to an aspect of the invention, it is preferable that the adjustment portion be separated from the above-mentioned at least either one of the first electrode and the second electrode that is formed in the formation area of the opening portion.

In the configuration of a liquid crystal display panel member according to an aspect of the invention, it is preferable that the first base have the adjustment portion if the part of the first electrode be formed in the formation area of the opening portion whereas the second base have the adjustment portion if the part of the second electrode be formed in the formation area of the opening portion.

In the configuration of a liquid crystal display panel member according to an aspect of the invention, it is preferable that the main surface of the adjustment portion be substantially parallel to the main surface of each of the first base and the second base in the formation area of the opening portion.

In the configuration of a liquid crystal display panel member according to an aspect of the invention, it is preferable that the adjustment portion comprise a material having the same characteristic as a material constituting the first electrode or the second electrode.

In the configuration of a liquid crystal display panel member according to an aspect of the invention, it is preferable that the sealing member further comprise an island portion that is located in the formation area of the opening portion.

In the configuration of a liquid crystal display panel member according to an aspect of the invention, it is preferable that the sealing member comprise a thermosetting resin.

A liquid crystal display panel according to an aspect of the invention includes: a liquid crystal display panel member according to an aspect of the invention; an opening seal member that seals the opening portion; and a liquid crystal between the first base and the second base, sealed with the sealing member and the opening seal member.

A liquid crystal display device according to an aspect of the invention includes: a liquid crystal display panel according to an aspect of the invention; and a backlight that is provided opposite to either the first base of the liquid crystal display panel or the second base of the liquid crystal display panel.

### ADVANTAGES

In the configuration of a liquid crystal display panel member according to an aspect of the invention, the sealing member constitutes an opening portion, which is open toward an end of each of the first base and the second base; at least a part of at least either one of the first electrode and the second electrode is arranged in the formation area of the opening portion; and at least either one of the first base and the second base has an adjustment portion which is arranged in the formation area of the opening portion and is configured to adjust a gap between the first base and the second base. Therefore, it is possible to make a gap between the first base and the second base measured at the part of at least either one of the first electrode and the second electrode that is formed in the formation area of the opening portion substantially equal to a gap between the first base and the second base measured at the end of each of the first base and the second base. Therefore, the resin material of the sealing member which is used for bonding the first base and the second base to each other and constitutes the opening portion for liquid crystal can be effectively prevented from flowing toward the image display area side due to a capillary phenomenon and/or the weight of the resin itself. The image display area side represents a side that would have a relatively small gap between the first base and the second base if the adjustment portion were not provided. As a result, it is possible to fully fill the resin over the entire formation area of the opening portion so as to form the sealing member thereat. Consequently, for example, when the opening portion is used as a filling-opening through which liquid crystal is injected, it is possible to prevent the entrainment of air bubbles during the injection thereof. In addition, it is possible to make the thickness of a liquid crystal layer uniform after the sealing of the opening portion with the use of the opening seal member. By this means, it is possible to provide a liquid crystal display device that is capable of displaying an image free from display unevenness.

### BEST MODE FOR CARRYING OUT THE INVENTION

With reference to the accompanying drawings, a liquid crystal display panel according to an exemplary embodiment of the invention is explained below.

Each of FIGS. 1-3 is a diagram that schematically illustrates a liquid crystal display panel according to an exemplary embodiment of the invention. FIG. 1 is a plan view that illustrates a liquid crystal display panel member according to an exemplary embodiment of the invention. FIGS. 2A and 2B are a set of partial enlarged plan views each of which illustrates the area A shown in FIG. 1. Specifically, FIG. 2A is a partial plan view that illustrates the area A of the first base which is viewed from a virtual surface which virtually splits the sealing member almost evenly in a thickness direction of the sealing member (according to the present embodiment of the invention, the area A is viewed in a downward direction). FIG. 2B is a partial plan view that illustrates the area A of the second base which is viewed from the virtual surface which virtually splits the sealing member almost evenly in the thickness direction of the sealing member (according to the present embodiment of the invention, the area A is viewed in an upper direction). FIG. 3 is a sectional view that illustrates the relevant components of a liquid crystal display panel member according to an exemplary embodiment of the invention, taken along the line I-I of FIG. 1.

A liquid crystal display panel member according to the present embodiment of the invention includes a first base 10, a second base 20, and a sealing member 30. As shown in FIG. 3, a liquid crystal layer has a display area including a plurality of pixels G for displaying an image. The display area is formed by providing a liquid crystal layer at an inner space that is demarcated by the first base 10 which is provided as a lower base, the second base 20 which is provided as an upper base, and the sealing member 30 and then sealing the liquid crystal layer.

The first base 10 includes a transparent substrate 11, first electrode(s) 12, and an alignment film. The first electrodes 12 are formed on one main surface of the transparent substrate 11. The alignment film (not shown in the drawing) is formed thereon.

The transparent substrate 11 supports the first electrodes 12 and the alignment film, and contributes to sealing a liquid crystal layer when a liquid crystal display panel is formed. As a material of the transparent substrate 11, a material that has at least a predetermined level of translucency (for example, a material that has a predetermined level of light-transmitting property or greater so as to allow transmitted light to be visually observed) such as glass or translucent plastic may be used.

The first electrode 12 is a member that applies a predetermined level of a voltage to the liquid crystal in a liquid crystal layer which is interposed between the first electrode(s) 12 of the first base 10 and second electrode(s) 21 of the second base 20, the latter of which is described later. The first electrode 12 is configured in such a manner that incident light that goes in at one surface side (which is the lower side according to the present embodiment of the invention) thereof transmits therethrough and then goes out at the other surface side (which is the upper side according to the present embodiment of the invention) thereof. As one configuration example, the first electrodes 12 may be formed as a plurality of electrodes that is arrayed in a direction that is either substantially parallel to or substantially perpendicular to one side/edge of the transparent substrate 11. Or, as another configuration example, the first electrode 12 may be formed as a single electrode corresponding to the image display area. In the configuration of a liquid crystal display panel member according to the present embodiment of the invention, as illustrated in FIG. 3, a plurality of first electrodes 12 is arrayed adjacent to one another so as to extend in a perpendicular direction with respect to the sheet face of the drawing, that is, in a direction perpendicular to the sheet thereof. A material that has both light transmitting property and electrical conductivity such as ITO or tin oxide may be used as the first electrode 12.

The alignment film serves to align the macroscopically-randomly-oriented liquid crystal molecules of a liquid crystal layer (which has small regularity) to a predetermined direction. The alignment film is formed over the surface of the transparent substrate 11 on which the first electrodes 11 are formed. A polyimide resin is an example of the material of the alignment film. The thickness of the alignment film may be appropriately set as needed.

The second base 20 includes a transparent substrate 21 and the second electrodes 22 on one main surface of the transparent substrate 21. In FIG. 3, a light shielding film 23, a color filter 24, a planarizing film 25, the second electrodes 22, and an alignment film (not shown in the drawing) are formed in the order of appearance herein on the one main surface of the transparent substrate 21.

The transparent substrate 21 is a member that contributes to sealing a liquid crystal layer. For example, the same material as that of the transparent substrate 11 is used for the transparent substrate 21.

The light shielding film 23 is a member that shields light (i.e., reduces the amount of transmission thereof to a predetermined value or smaller). The light shielding film 23 is formed at an area between the color filters 24 and an area outside the image display area. Exemplary materials of the light shielding film 23 may be a resin (e.g., acrylic resin) that contains a dye or a pigment that has a color having high light shielding property (e.g., black) and a metal film made of Cr or the like. The light shielding film 23 having such high light shielding property makes it possible to increase the contrast ratio of a display image.

The color filter 24 is formed with the addition of a dye or a pigment to a member such as an acrylic resin that selectively absorbs a light component of predetermined wavelengths among all light entered into the color filter 24, and that selectively transmits another light component of another predetermined wavelength among all light entered into the color filter 24. The color filters 24 may include, for example, a red (R) color filter that selectively transmits a light component that has a wavelength region of red visible light, a green (G) color filter that selectively transmits a light component that has a wavelength region of green visible light, and a blue (B) color filter that selectively transmits a light component that has a wavelength region of blue visible light. The thickness of the color filter 24 is appropriately set in consideration of the transmission amount of light, though not necessarily limited thereto. For example, the thickness of the color filter 24 is set at 1.0 μm.

The planarizing film 25 is a film for making a smooth layer surface by leveling an irregular layer surface that is formed as a result of the deposition of the light shielding film 23 and the color filter 24. An example of the material of the planarizing film 25 is a transparent resin such as an acrylic resin or the like.

The second electrode 22 is a member for applying a predetermined level of a voltage to the liquid crystal of a liquid crystal layer which is interposed between the first electrode(s) 12 of the first base 10 and the second electrode(s) 21 of the second base 20. The second electrode 22 is configured in such a manner that incident light that goes in at one surface side (the lower side) thereof transmits therethrough and then goes out from the other surface side (the upper side) thereof. Or, the second electrode 22 is configured in such a manner that incident light that goes in at the above-mentioned other surface side (the upper side) thereof transmits therethrough and then goes out from the above-mentioned one surface side (the lower side) thereof. As one configuration example, the second electrodes 22 may be formed as a plurality of electrodes that is arrayed in a direction that is either substantially parallel to or substantially perpendicular to one side/edge of the transparent substrate 21. Or, as another configuration example, the second electrode 22 may be formed as a single electrode corresponding to the image display area. In FIG. 3, a plurality of second electrodes 22 is arrayed adjacent to one another so as to extend in a parallel to the paper sheet of FIG. 3. The same material as that of the first electrode 12 may be used for the second electrode 22.

The alignment film serves to align the macroscopically-randomly-oriented liquid crystal molecules of a liquid crystal layer (which has small regularity) to a predetermined direction (for example, a direction intersecting with the orientation direction of the alignment film). The alignment film is formed over the surface of the planarizing film 25 on which the second electrodes 22 are formed. An example of the material of the alignment film is a polyimide resin. The thickness of the alignment film may be appropriately set as needed. For example, it is set at 0.05 μm.

The sealing member 30 contributes to sealing a liquid crystal layer that is sandwiched between the first base 10 and the second base 20. In addition, the sealing member 30 causes the first base 10 and the second base 20 to adhere to each other with a predetermined gap left between the first base 10 and the second base 20. The sealing member 30 may be made of, for example, a resin that contains a thermosetting resin having thermo-hardening property, an insulation material (e.g., an insulating resin), and inner sealing member spacers 30a including minute particles that are made of glass fiber, ceramic, or the like and electro-conductive minute particles having Ni—Au plated coats on the surfaces of resin minute particles.

As shown in FIG. 3, the first base 10 and the second base 20 are bonded to each other with the use of the sealing member 30 in such a manner that the first electrodes 12 of the first base 10 and the second electrodes 22 of the second base 20 are provided opposite to each other at the area sealed by the sealing member 30, and a plurality of pixels is formed at the sealed area. The sealing member 30 forms an open area portion which is open toward an end of each of the first base 10 and the second base 20. In the present embodiment, the open area portion functions as a filling opening 31 through which liquid crystal is to be injected.

A liquid crystal display panel with a liquid crystal display panel member according to the present embodiment of the invention has, as shown in FIG. 4, a filling-opening sealing member 50 and a liquid crystal layer 51. The filling-opening sealing member 50 seals the filling opening 31. The liquid crystal layer 51, which is made of liquid crystal, is sandwiched between the first base 10 and the second base 20 and sealed with the non-filling-opening sealing member 30 and the filling-opening sealing member 50. The filling-opening sealing member 50 is made of an ultraviolet (UV) curing resin or the like. The liquid crystal layer 51 contains liquid crystal that has electrical anisotropy, optical anisotropy, dynamical/mechanical anisotropy, or magnetic anisotropy. The liquid crystal of the liquid crystal layer 51 has both the periodicity of crystal, that is, solid, and the fluidity of liquid. Exemplary liquid crystals for the liquid crystal layer 51 are nematic liquid crystal, cholesteric liquid crystal, and smectic liquid crystal. If a backlight is provided below the first base 10 of a liquid crystal display panel member according to the present embodiment of the invention, a liquid crystal device according to an exemplary embodiment of the invention is obtained. The position of a backlight is not limited to the above example as long as a backlight is provided either below the first base 10 of a liquid crystal display panel member or above the second base 20 of a liquid crystal display panel member.

In the configuration of a liquid crystal display panel member according to the present embodiment of the invention, the sealing member 30 has an open area portion, which is open toward an end of each of the first base 10 and the second base 20. The open area portion corresponds to the filling opening 31. As shown in FIGS. 2 and 3, it should be particularly noted that a part of at least either one of the first electrode(s) 12 and the second electrode(s) 22 is formed in the formation area B of the filling opening 31, and further that at least either one of the first base 10 and the second base 20 has a gap adjustment portion 40 in the formation area B of the filling opening 31, which is the portion for adjusting the gap distance between the first base 10 and the second base 20.

The gap adjustment portion 40 is formed at an area that is closer to the above-mentioned end of each of the first base 10 and the second base 20 than the area of the above-mentioned part of at least either one of the first electrode(s) 12 and the second electrode(s) 22 that is formed in the formation area B of the filling opening 31. With such a structure, as illustrated in FIG. 3, it is possible to make the gap distance d1 between the first base 10 and the second base 20 measured at the image-display-area-side end of the formation area B of the filling opening 31 substantially equal to the gap distance d2 between the first base 10 and the second base 20 measured at the opposite panel-end-side end of the formation area B of the filling opening 31. When the sealing member 30 is formed, a thermosetting resin such as a thermosetting epoxy resin or the like that contains the inner sealing member spacers 30a is coated on the main surface of either one of the first base 10 and the second base 20 by a screen printing method or the like. After the coating of the thermosetting resin thereon, the first base 10 and the second base 20 are bonded to each other. Then, the thermosetting resin is hardened by heat treatment. During such a thermosetting process, it is possible to make the gap distance d1 substantially equal to the gap distance d2. Therefore, it is possible to effectively prevent a thermosetting resin, which is the material of the sealing member 30, from flowing toward the image display area side, which is a side that would have a relatively small gap between the first base 10 and the second base 20 if the gap adjustment portion 40 were not provided, due to a capillary phenomenon and/or the weight of the thermosetting resin itself. For this reason, it is possible to fully fill the thermosetting resin over the entire formation area B of the filling opening 31 so as to form the sealing member 30 thereat. Consequently, in the configuration of a liquid crystal display panel shown in FIG. 4, it is possible to make the gap distance D1 between the first base 10 and the second base 20 measured in the image display area substantially equal to the gap distance D2 between the first base 10 and the second base 20 measured in the neighborhood of the sealing member 30 after the filling of liquid crystal through the filling opening 31 and the subsequent sealing of the filling opening 31 with the use of the filling-opening sealing member 50, which is made of a UV curing resin or the like. Thus, it is possible to provide a liquid crystal device that is capable of displaying an image that is free from display unevenness.

Next, various embodiments of the position of the gap adjustment portion 40 are explained below. The position at which the gap adjustment portion 40 is formed can be appropriately set as long as the gap adjustment portion 40 can effectively provide such a uniform gap distance that allows the material of the sealing member 30 to be filled up to the end of the first base 10 and the second base 20. Accordingly, the position of the gap adjustment portion 40 is adjusted in accordance with the formation position of the first electrode 12 and the second electrode 22. For example, if a part of the first electrode(s) 12 only is formed in the formation area B of the filling opening 31, the gap adjustment portion 40 may be formed either the above-mentioned one main surface (i.e., the upper surface) of the first base 10 or the above-mentioned one main surface (i.e., the lower surface) of the second base 20. If a part of the second electrode(s) 22 only is formed in the formation area B of the filling opening 31, the gap adjustment portion 40 may be formed either the above-mentioned one main surface (i.e., the upper surface) of the first base 10 or the above-mentioned one main surface (i.e., the lower surface) of the second base 20. Preferably, the gap adjustment portion 40 should be formed at the end area on the same base (either the first base 10 or the second base 20) as the base on which the above-mentioned part of either one of the first electrode(s) 12 and the second electrode(s) 22 is formed in the formation area B of the filling opening 31. With such a preferred structure, it is possible to eliminate a step that is formed as a result of the formation of the first electrode 12 and the second electrode 22 with high level-difference elimination precision. Thus, it is possible to achieve greater uniformity in the gap between the first base 10 and the second base 20 at the formation area B of the filling opening 31. By this means, even in a case where the sealing member 30 having a large viscosity down is used, it is possible to fully form the sealing member 30 up to the end of the first base 10 and the second base 20 in the formation area B of the filling opening 31. It is preferable that the gap adjustment portion 40 should be formed up to an area portion that is open to the end of the first base 10 and the second base 20 in the formation area B of the filling opening 31. With such a preferred structure, it is possible to fill and form the sealing member 30 up to the end of the first base 10 and the second base 20 in a more uniform manner.

The gap adjustment portion 40 is made of, for example, the transparent substrate 11 that constitutes a part of the first base 10, the transparent substrate 22 that constitutes a part of the second base 20, the first electrode 12, the second electrode 22, the light shielding film 23, the color filter 24, or the planarizing film 25. The gap adjustment portion 40 may be formed as an extended portion of any of these components. Or, the gap adjustment portion 40 may be formed as a component member separated therefrom. It is preferable that the gap adjustment portion 40 should be formed as a dummy electrode that is made of the same material as that of the first electrode 12 and the second electrode 22. The gap adjustment portion 40 that is formed as such a dummy electrode has a great force of adhesion to the transparent substrate 11 and transparent substrate 22. For this reason, with such a preferred structure, it is possible to seal the first base 10 and the second base 20 strongly by means of the sealing member 30 even in a case that the sealing member 30 is formed on the gap adjustment portion 40.

In addition, it is preferable to form the gap adjustment portion 40 in such a manner that the main surface of the gap adjustment portion 40 is substantially parallel to the main surface of each of the first base 10 and the second base 20 in the formation area B of the filling opening 31. With such a preferred structure, it is possible to make the gap distance d1 shown in FIG. 3 more equal to the gap distance d2 shown therein. Therefore, it is possible to fully form the sealing member 30 up to the end of the first base 10 and the second base 20 in the formation area B of the filling opening 31.

As shown in FIG. 2, the sealing member 30 further forms an island portion 32 that is located at an inside position of each of the first base 10 and the second base 20 as viewed from the gap adjustment portion 40. With such a structure, it is possible to achieve a more uniform gap between the first base 10 and the second base 20 in the formation area B of the filling opening 31. Therefore, even in a case where the sealing member 30 having a large viscosity down is used, it is possible to fully fill and form the sealing member 30 up to the end of the first base 10 and the second base 20 in the formation area B of the filling opening 31. The island portion 32 may have any form, area size, or the like as long as an injection path through which liquid crystal can be filled in is left. In addition, the number of the island portion 32 may be one or more. If the island portion 32 is formed at the center portion between two portions of the sealing member 33 that are opposite to each other, it is easier to achieve better uniformity in the gap between the first base 10 and the second base 20 at the formation area B of the filling opening 31.

The liquid crystal display panel shown in FIG. 4 includes the liquid crystal display panel member explained above, and the liquid crystal display panel is combined with a backlight. Therefore, it is possible to make the cell gap D1, which is the distance between the first base 10 and the second base 20 measured in the image display area, equal to the cell gap D2, which is the distance between the first base 10 and the second base 20 measured in the neighborhood of the sealing member 30, whereby it is possible to form the liquid crystal layer 51 in a uniform manner. For this reason, it is possible to provide a liquid crystal device that is capable of displaying an image that is free from display unevenness.

Although various exemplary embodiments of the present invention are described above, the invention is not limited to these exemplary embodiments described herein. Various changes and modifications may be included within the scope of the invention.

### BRIEF DESCRIPTION OF DRAWINGS

FIG. 1 is a plan view that illustrates the configuration of a liquid crystal display panel member according to an exemplary embodiment of the invention;

FIGS. 2A and 2B are a set of enlarged views each of which illustrates the area A shown in FIG. 1; specifically, FIG. 2A is a partial plan view that illustrates the area A of the first base which is viewed from a virtual surface which virtually splits the sealing member almost evenly in a thickness of the sealing member (in the embodiment, the area A is viewed in a downward direction); FIG. 2B is a partial plan view that illustrates the area A of the second base which is viewed in a direction from the virtual surface which virtually splits almost evenly in the thickness of the sealing member (in the embodiment, the area A is viewed in an upper direction);

FIG. 3 is a sectional view that illustrates the relevant components of a liquid crystal display panel member according to an exemplary embodiment of the invention, taken along the line I-I of FIG. 1;

FIG. 4 is a sectional view that illustrates, in the neighborhood of a filling opening thereof, the relevant components of a liquid crystal display panel that includes a liquid crystal display panel member according to an exemplary embodiment of the invention;

FIG. 5 is a plan view that illustrates the configuration of a liquid crystal display panel member;

FIG. 6 is a partial plan view that illustrates, in an enlarged view, the area C of the liquid crystal display panel member that is shown in FIG. 5; specifically, FIG. 6 is a partial plan view that illustrates a virtually split sealing member, which is assumed to be split into two parts at substantially the center thereof when viewed in the direction of thickness thereof, together with a second base (which is provided as an upper base);

FIG. 7 is a sectional view that illustrates the relevant components of a liquid crystal display panel member, taken along the line I-I of FIG. 5; and

FIG. 8 is a sectional view that illustrates, in the neighborhood of a filling opening thereof, the relevant components of a liquid crystal display panel that includes a liquid crystal display panel member.

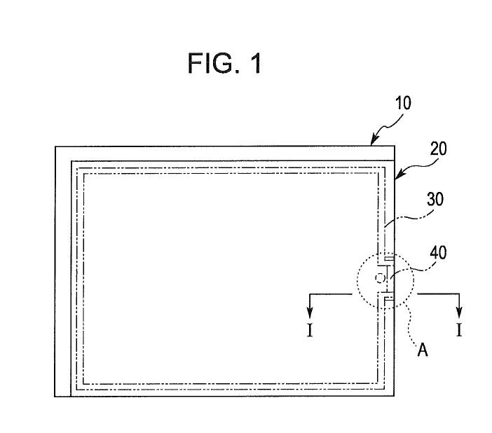

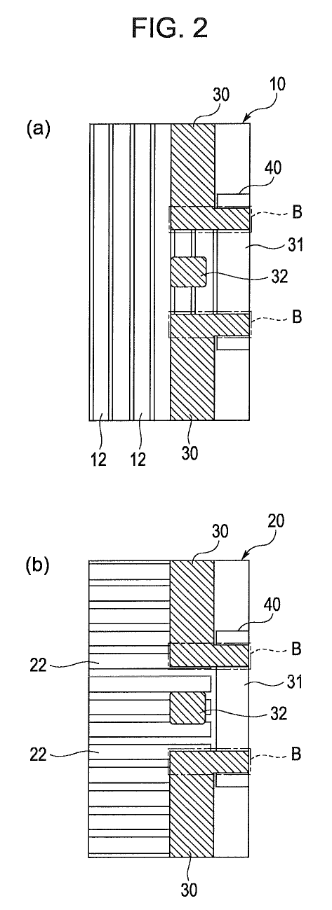

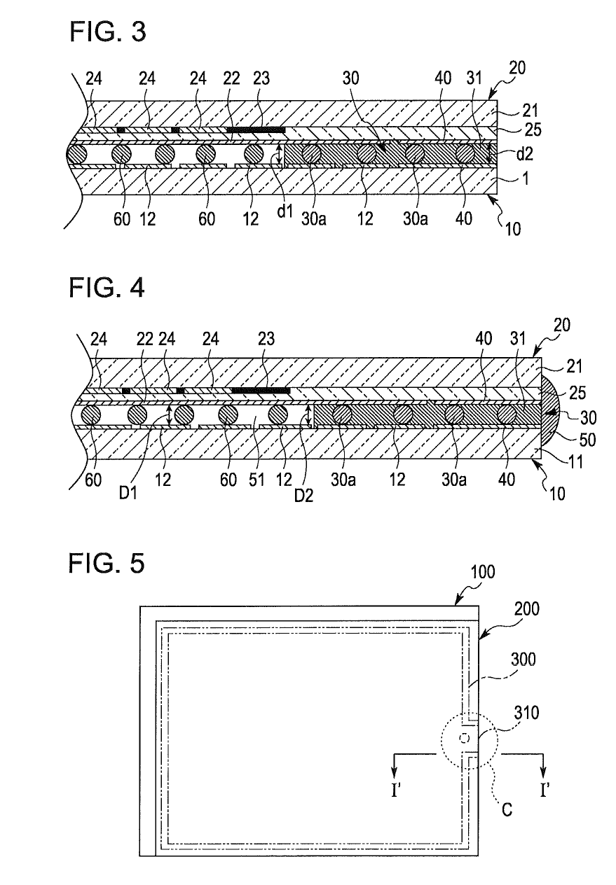

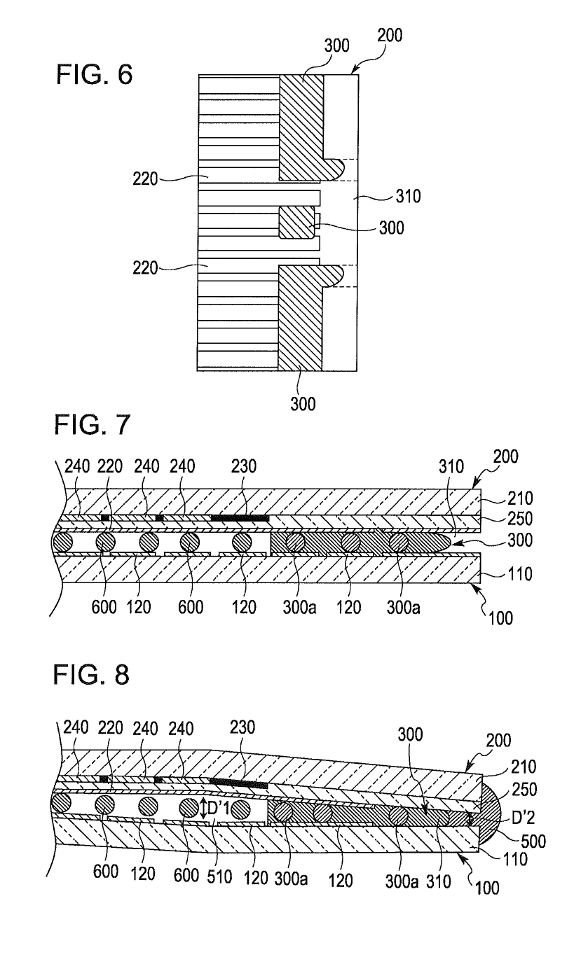

### REFERENCE NUMERALS

10 First base
10 Transparent Substrate
12 First Electrode
20 Second base
21 Transparent Substrate
22 Second Electrode
23 Light Shielding Film
24 Color Filter
25 Planarizing Film
30 Sealing Member
30a Inner Sealing Member Spacer
31 Filling opening
32 Island Portion
40 Gap Adjustment Portion
50 Filling-opening Sealing Member
51 Liquid Crystal Layer
60 Inner Surface Spacer
B Formation Area of Filling opening

1. A liquid crystal display panel member comprising:
a first base that includes a first transparent substrate and a first electrode, the first electrode being formed on one main surface of the first transparent substrate;
a second base that includes a second transparent substrate and a second electrode, the second electrode being formed on one main surface of the second transparent substrate; and
a sealing member for sealing liquid crystal to be placed between the first base and the second base,
wherein the sealing member constitutes an opening portion, which is open toward an end of each of the first base and the second base;
a part of at least either one of the first electrode and the second electrode is arranged in the formation area of the opening portion; and
at least either one of the first base and the second base has an adjustment portion in the formation area of the opening portion, wherein the adjustment portion is closer to the end of each of the first base and the second base than the first electrode or the second electrode in a condition that the adjustment portion is separated from the either one of the first and the second electrodes, and wherein the adjustment portion is configured to adjust a gap between the first base and the second base.

2. The liquid crystal display panel member according to claim 1, wherein the first base has the adjustment portion if the part of the first electrode is formed in the formation area of the opening portion whereas the second base has the adjustment portion if the part of the second electrode is formed in the formation area of the opening portion.

3. The liquid crystal display panel member according to claim 1, wherein the main surface of the adjustment portion is substantially parallel to the main surface of each of the first base and the second base in the formation area of the opening portion.

4. The liquid crystal display panel member according to claim 1, wherein the adjustment portion comprises a material having the same characteristic as a material constituting the first electrode or the second electrode.

5. The liquid crystal display panel member according to claim 1, wherein the sealing member further comprises an island portion that is located in the formation area of the opening portion.

6. The liquid crystal display panel member according to claim 1, wherein the sealing member comprises a thermosetting resin.

7. A liquid crystal display panel comprising: the liquid crystal display panel member according to any of claim 1;
an opening seal member that seals the opening portion; and
a liquid crystal between the first base and the second base, sealed with the sealing member and the opening seal member.

8. A liquid crystal display device comprising:
the liquid crystal display panel according to claim 7; and
a backlight that is provided opposite to either the first base of the liquid crystal display panel or the second base of the liquid crystal display panel.
